(19) United States
(12) Patent Application Publication
(10) Pub. No.: US 2017/0044996 A1
(43) Pub. Date: Feb. 16, 2017

(54) METHOD FOR OPERATING A BURNER ASSEMBLY

(71) Applicant: Siemens Aktiengesellschaft, Munich (DE)

(72) Inventors: Eberhard Deuker, Mülheim an der Ruhr (DE); Boris Ferdinand Kock, Ratingen (DE); Dieter Simon, Mülheim an der Ruhr (DE)

(73) Assignee: Siemens Aktiengesellschaft, Munich (DE)

(21) Appl. No.: 15/306,574

(22) PCT Filed: Apr. 17, 2015
(86) PCT No.: PCT/EP2015/058393

§ 371 Date: Oct. 25, 2016

(30) Foreign Application Priority Data
May 5, 2014 (EP) 14166969.7

(51) Int. Cl. F02C 9/48

(52) U.S. Cl. CPC F02C 9/48

(57) ABSTRACT

A method for operating a burner assembly, in particular a burner assembly of a gas turbine, wherein an evaluation variable representing the combustion stability is determined and at least one control variable is altered, at least based on the determined evaluation variable, when the determined evaluation variable does not fall within a previously defined desired range, the desired range of the evaluation variable being constant over the entire output range of the machine, and wherein the evaluation variable is determined based on measured maximum actual amplitudes in previously defined frequency bands and measured actual outputs of the burner assembly.

### CROSS REFERENCE TO RELATED APPLICATIONS

This application is the US National Stage of International Application No. PCT/EP2015/058393 filed Apr. 17, 2015, and claims the benefit thereof. The International Application claims the benefit of European Application No. EP14166969 filed May 5, 2014. All of the applications are incorporated by reference herein in their entirety.

### FIELD OF INVENTION

The present invention relates to a method for operating a burner assembly, in particular a burner assembly of a gas turbine, wherein an evaluation variable representing the combustion stability is determined and at least one control variable is altered at least on the basis of the determined evaluation variable.

### BACKGROUND OF INVENTION

During operation of a gas turbine system, in addition to maintaining output, efficiency and emission limits, it is particularly important to keep the combustion stability within a safe operating range. In the present case, combustion stability is understood as the thermo-acoustic behavior of the combination of burners and combustion chambers. The excitation of thermo-acoustic modes can result in strong interactions in the combustion chamber, which can cause mechanical damage to the machine. Accordingly, it is important to avoid frequency bands, in which harmful maximum amplitudes occur. In this connection, closed control loops have recently been increasingly frequently used with the aim of preventing critical frequency bands and in this way controlling the thermo-acoustic behavior. For this purpose, the critical frequency bands are monitored in separate control loops which are combined in a controller. In particular, the total fuel volume flow supplied to the burner assembly, the division of the total fuel volume flow into individual burner stages of the burner assembly and the positioning of adjustable inlet guide vanes of the burner assembly, to name just a few examples, are used as control variables. A disadvantage of controls of this type however is that the provision of several control loops is associated with high costs. In addition, the critical frequency bands vary as a function of the output ranges of the burner assembly. Frequency bands which have no significant influence on the combustion stability in a first output range can have a negative influence on this in another output range and vice versa. Accordingly, different control targets can compete with one another if different frequencies occur in the same output range and the remedial measures or control variables are different.

### SUMMARY OF INVENTION

Starting from this prior art, it is an object of the present invention to provide an alternative method of the type specified initially, by means of which a reliable and inexpensive control of the combustion stability is achieved.

In order to solve this object, the present invention provides a method of the type specified initially, which is characterized in that the desired range of the evaluation variable is constant over the entire output range of the machine and the evaluation variable is determined on the basis of measured maximum actual amplitudes in previously defined frequency bands and measured actual outputs of the burner assembly. In this way, the combustion stability can be kept within a safe operating range by means of simple means based on a single evaluation variable and therefore by means of a single control loop over the entire output range of the machine without competing control aims.

With a view to the control of thermo-acoustic modes, the actual amplitudes are advantageously alternating pressure actual amplitudes or component acceleration actual amplitudes.

Advantageously the evaluation variable is determined using output-dependent weighting factors and/or frequency-dependent weighting factors.

The output-dependent weighting factors are used to define the negative influence of a frequency band as a function of the output range of the burner assembly. The output-dependent weighting factors are therefore selected to be either higher or lower with increasing negative influence. Frequency ranges which have no negative influence on the combustion stability in certain output ranges of the driving curve since no harmful maximum amplitudes for the combustion stability occur in these, can be “switched off” thanks to such output-dependent weighting factors so that they are not taken into account when determining the evaluation variable. In this way, a falsifying influence of irrelevant frequency ranges on the determined accompanying variable can be prevented. Other frequency ranges which have a negative influence on the combustion stability in certain output ranges of the driving curve as a result of harmful maximum amplitudes can be weighted separately depending on their relevance for the individual output ranges so that these are incorporated more or less strongly in the determined evaluation variable. The output-dependent weighting factors therefore enable an evaluation over the entire output range of the machine or the burner assembly.

The frequency-dependent weighting factors are used to define the absolute contribution of the respective frequency bands or the maximum amplitudes of the respective frequency bands to the evaluation variable. The background here, for example, can be a different importance of the maximum amplitudes of the individual frequency bands to the combustion stability. Thus, the frequency-dependent weighting factors, similarly to the output-dependent weighting factors, can be selected to be either higher or lower with increasing negative influence. In other words, the frequency-dependent weighting factors can be selected in such a manner that the maximum amplitudes of the individual frequency bands are brought to a comparable level with regard to their negative influence on the combustion stability so that they are incorporated suitably weighted in the determined evaluation variable. In this way, it is possible to keep the desired range of the evaluation variable constant over the entire output range.

In particular, the evaluation variable is defined as the sum g_{f1}·k₁·A₁²+g_{f2}·k₂·A₂²+ . . . +g_{fn}·kₙ·Aₙ² wherein A₁ to Aₙ represent the maximum amplitudes in the frequency bands f₁ to fₙ, g_{f1} to g_{fn} represent the output-dependent weighting factors of the frequency bands f₁ to fₙ, and k₁ to kₙ represent the frequency-band-dependent weighting factors.

Advantageously, the output-dependent weighting factors g_{f1} to g_{fn} have a value between 0 and 1. Thus, for example, the weighting factors g_{fi} (where i=1 to n) can be defined in sections over the relative output of the burner assembly. For example, the output-dependent weighting factor g_{fi} can have the value 0 when a<P*≦b, wherein P* represents the actual output of the burner assembly, the value 0.5 when c<P*≦d, and the value 1 when e<P*≦f, wherein the variables a, b, c, d, e, and f characterize the output ranges in which the respective frequency bands make a contribution to the evaluation variable. These values vary in a machine-specific manner and can be adapted from case to case. The respective value of the output-dependent weighting factors g_{fi}, for example, 0, 0.5, or 1 can also be selected in a machine-specific manner. Similarly the frequency-dependent weighting factors k₁ to kₙ can be assigned values from 0 to 1.

### DETAILED DESCRIPTION OF INVENTION

According to one embodiment of the method according to the invention, the at least one control variable comprises the total fuel volume flow supplied to the burner assembly and/or the total combustion air volume flow supplied to the burner assembly and/or a division of the total fuel volume flow supplied to the burner assembly into individual burner stages of the burner assembly and/or the positioning of adjustable inlet guide vanes of the burner assembly.

The essential advantage of the method according to the invention compared with known methods, which individually monitor critical frequency bands and modify control variables when critical frequencies occur, in order to prevent a negative influence on the combustion stability, consists in that competing control aims cannot occur. Accordingly a correct operating mode is always ensured. Furthermore, the method according to the invention can be implemented simply and inexpensively with a single control.

What is claimed is:

1. A method for operating a burner assembly, the method comprising:
determining an evaluation variable representing the combustion stability, and
altering at least one control variable at least on the basis of the determined evaluation variable when the determined evaluation variable does not lie within a previously defined desired range,
wherein the desired range of the evaluation variable is constant over the entire output range of the machine, and
wherein the evaluation variable is determined on the basis of measured maximum actual amplitudes in previously defined frequency bands and measured actual outputs of the burner assembly.

2. The method as claimed in claim 1,
wherein the actual amplitudes are alternating pressure actual amplitudes or component acceleration actual amplitudes.

3. The method as claimed in claim 1,
wherein the evaluation variable is determined using output-dependent weighting factors and/or frequency-dependent weighting factors.

4. The method as claimed in claim 1, wherein the evaluation variable is defined as the sum
g_{f1}·k₁·A₁²+g_{f2}·k₂·A₂²+ . . . +g_{fn}·kₙ·Aₙ²
wherein A₁ to Aₙ represent the maximum amplitudes in the frequency bands f₁ to fₙ, g_{f1} to g_{fn} represent output-dependent weighting factors of the frequency bands f₁ to fₙ, and k₁ to kₙ represent frequency-band-dependent weighting factors.

5. The method as claimed in claim 4,
wherein the output-dependent weighting factors g_{f1} to g_{fn} and/or the frequency-dependent weighting factors k₁ to kₙ have a value between 0 and 1.

6. The method as claimed in claim 1,
wherein the at least one control variable comprises the total fuel volume flow supplied to the burner assembly and/or the total combustion air volume flow supplied to the burner assembly and/or a division of the total fuel volume flow supplied to the burner assembly into individual burner stages of the burner assembly and/or the positioning of adjustable inlet guide vanes of the burner assembly.

7. The method of claim 1,
wherein the burner assembly is a burner assembly of a gas turbine.
